(19) United States
(12) Patent Application Publication
(10) Pub. No.: US 2013/0275148 A1
(43) Pub. Date: Oct. 17, 2013

(54) SMART HOSPITAL CARE SYSTEM

(71) Applicants: Prabhaker Attaluri, Aurora, IL (US); Mickey Iqbal, Plano, TX (US); Calvin D. Lawrence, Lithonia, GA (US)

(72) Inventors: Prabhaker Attaluri, Aurora, IL (US); Mickey Iqbal, Plano, TX (US); Calvin D. Lawrence, Lithonia, GA (US)

(73) Assignee: INTERNATIONAL BUSINESS MACHINES CORPORATION, Armonk, NY (US)

(21) Appl. No.: 13/445,299

(22) Filed: Apr. 12, 2012

(51) Int. Cl. G06Q 50/24

(52) U.S. Cl. 705/3

(57) ABSTRACT

A system and associated method for automatically controlling a hospital equipment of in-patient care environment is performed by a module coupled to a classification database, an Inference Engine (IE), a Truth Maintenance System (TMS), and the hospital equipment. Upon admitting a patient, a patient record related to the patient is created and events for the patient are recorded. Based on inference rules of the IE, inferred event data is generated and subsequently control data to manipulate the hospital equipment is generated. Pursuant to new event affecting truth of the inferred event data, the inferred event data may be renewed and new control data based on the renewed inferred event data is created to ensure that the control data is based on the latest event related to the patient.

### BACKGROUND

Conventionally, elements of hospital room environment for in-patients are manually controlled, resulting in expensive, inefficient and unsafe management of hospital rooms and degraded quality of care for the in-patients. An automated hospital care system improves quality of care and reduces chance for errors.

### BRIEF SUMMARY

According to one embodiment of the present invention, a method for automatically controlling a hospital equipment of in-patient care environment comprises: configuring, by a processor of a computer system running a module for the in-patient care environment, wherein the in-patient care environment comprises the hospital equipment, the module, a event data from data sources for the module, wherein the data sources comprises patient registration, caretaker recordation, and sensor measurement, wherein the hospital equipment performs the sensor measurement; generating at least one inferred event data by running the IE over the configured event data pursuant to predefined inference rules of the IE; storing said at least one inferred event data from said generating as a respective inference data node of the TMS such that a respective belief associated with said at least one inferred event data varies logically dependent to other data nodes within the TMS; producing control data by applying a respective non-monotonic logic (NML) to content of the respective inference data node of the TMS from said storing; updating the TMS by adding a control data node corresponding to the control data from said producing; and sending content of the control data node of the TMS from said updating to the hospital equipment such that the hospital equipment operates pursuant to the content of the control data node.

According to one embodiment of the present invention, a computer program product comprises a computer readable memory unit that embodies a computer readable program code. The computer readable program code contains instructions that, when run by a processor of a computer system, implement a method for automatically controlling a hospital equipment of in-patient care environment.

According to one embodiment of the present invention, a computer system comprises a processor, a memory coupled to the processor, and a computer readable storage device coupled to the processor, said storage device containing program code configured to be executed by the processor via the memory to implement a method for automatically controlling a hospital equipment of in-patient care environment.

According to one embodiment of the present invention, a process for supporting computer infrastructure, said process comprising providing at least one support service for at least one of creating, integrating, hosting, maintaining, and deploying computer-readable code in a computing system, wherein the code in combination with the computing system is capable of performing a method for automatically controlling a hospital equipment of in-patient care environment.

### BRIEF DESCRIPTION OF THE SEVERAL VIEWS OF THE DRAWINGS

FIG. 1 illustrates a system 10 for automatically controlling hospital room environment, in accordance with embodiments of the present invention.

FIG. 2 illustrates the SHCS 31 of FIG. 1, for automatically controlling hospital room environment, in accordance with embodiments of the present invention.

FIG. 3 is a flowchart depicting a method for automatically controlling hospital room environment as performed by the SHCS module 35 of FIG. 1, in accordance with the embodiments of the present invention.

FIG. 4 is a flowchart depicting input data processing on the CDB in step 100 of FIG. 3, as performed by the SHCS module 35 of FIG. 1, in accordance with the embodiments of the present invention.

FIG. 5 illustrates a computer system 90 used for automatically controlling in-patient care environment, in accordance with the embodiments of the present invention.

### DETAILED DESCRIPTION

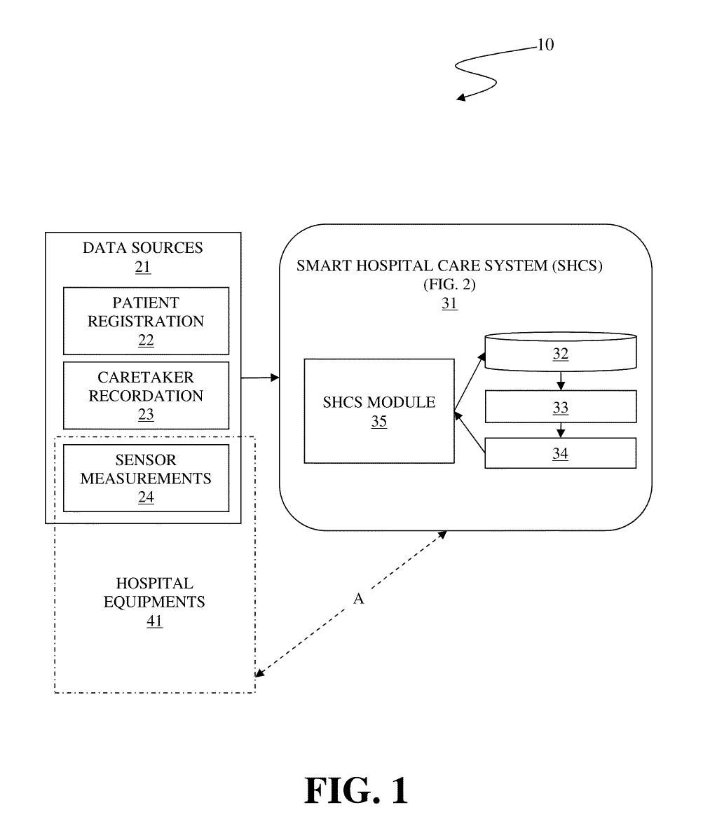

FIG. 1 illustrates a system 10 for automatically controlling in-patient care environment, in accordance with embodiments of the present invention.

The system 10 comprises hospital equipments 41, data sources 21, and a Smart Hospital Care System (SHCS) 31. The system 10 may be employed for, inter alia, intensive care unit, neo-natal unit, etc., wherein manual control of the environment may result in critical situation and endangerment of patient safety.

The hospital equipments 41 are automatically controlled by control data sent from the SHCS 31 and input sensor data to the SHCS 31, as noted by Arrow A. Examples of the hospital equipments 41 may be, inter alia, heating, ventilation, and air conditioning (HVAC) machines, medical monitoring equipments such as an electrocardiographic (ECG) monitor, etc. Pursuant to content of the control data, the hospital equipments 41 may, inter alia, adjust room heating and air conditioning settings, safely changing bed alignment, turning lights on/off, ordering right food choices based on patient condition, etc.

The data sources 21 for the SHCS 31 comprise patient registration 22, caretaker recordation 23, and sensor measurements 24 of the hospital equipments 41. The data sources 21 originate input data provided to the SHCS 31.

The SHCS 31 comprises a classification database (CDB) 32, an inference engine (IE) 33, a truth maintenance system (TMS) 34, and a SHCS module 35. In one embodiment of the disclosure, the SHCS 31 may be implemented as an end-to-end, cloud-based solution providing a pay-by-usage model of software application such that individual health facilities easily adopt the SHCS 31 without incurring significant infrastructure investment and maintenance cost. In this specification, terms “belief”, “assertion”, and “assumption” are used interchangeably to indicate an event description within the TMS 34.

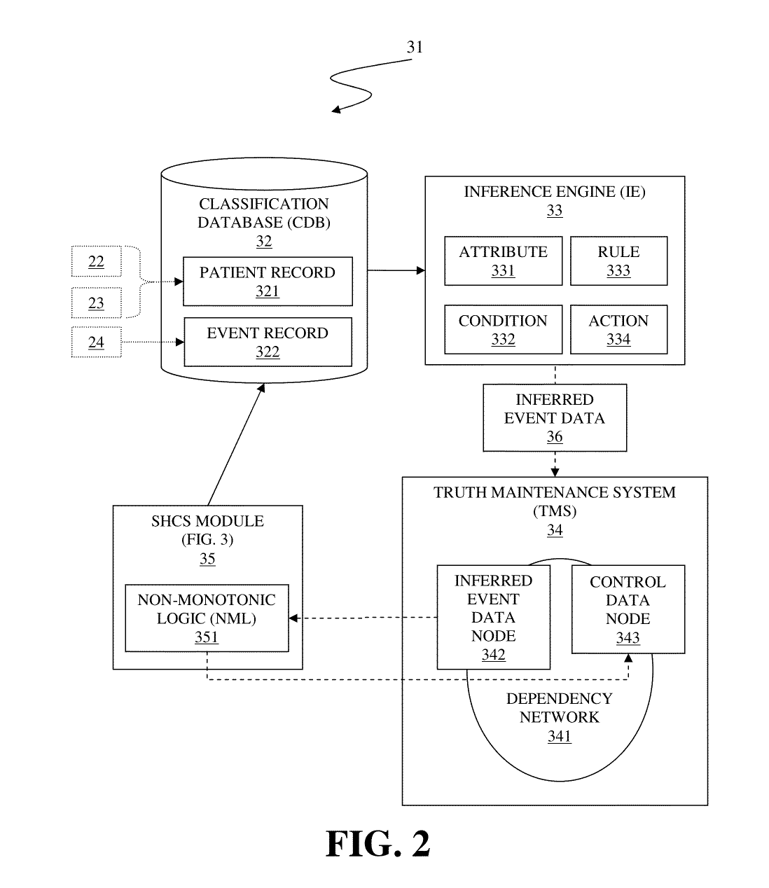

The CDB 32 stores records necessary for the IE 33 as being generated from the input data from the data sources 21. The IE 33 generates inferred data based on the records of CDB 32 and stores the inferred data in the TMS 34. The SHCS module 35 orchestrates operations of the CDB 32, the IE 33, and the TMS 34, in generating control data based on the inferred data from the TMS 34 and in storing the generated control data back to the TMS 35. The generated control data is transmitted to the hospital equipments 41 to adjust operational states of the hospital equipments 41 pursuant to the control data. See descriptions of FIG. 2 infra for details on components of the SHCS 31.

FIG. 2 illustrates components of the SHCS 31 of FIG. 1 supra, for automatically controlling hospital room environment, in accordance with embodiments of the present invention.

The CDB 32 comprises at least one patient record and at least one event record. A patient record 321 of said at least one patient record represents information regarding a respective patient. In one embodiment of the present invention, the patient record 321 comprises a first attribute of Patient Identification in integer data type, a second attribute of First Name in text data type, a third attribute of Last Name in text data type, a fourth attribute of Gender in text data type, a fifth attribute of Date Of Birth (DOB) in date data type, a sixth attribute of Address in text data type, a seventh attribute of Contact Number in integer data type, a eighth attribute of Doctor Identification in integer data type, a ninth attribute of Registration Date in date data type, a tenth attribute of Admission Date in date data type, an eleventh attribute of Diagnosis in text data type, a twelfth attribute of Treatment Description in text data type, and a thirteenth attribute of Medication in text data type.

An event record 322 of said at least one event record represents information regarding an event relevant to care of each patient. In the same embodiment of the present invention, the event record 322 comprises a first attribute of Event Identification in integer data type, a second attribute of Event Location in text data type, a third attribute of Event Source in text data type, a fourth attribute of Event Description in text data type, a fifth attribute of Patient Identification in integer data type, a sixth attribute of Nurse Identification in integer data type, a seventh attribute of Duty Doctor Identification in integer data type, a eighth attribute of Technician Identification in integer data type, a ninth attribute of Date Of Record in date data type, a tenth attribute of Time Of Record in time data type, an eleventh attribute of Room Temperature in integer data type, a twelfth attribute of Blood Pressure (BP) in integer data type, and a thirteenth attribute of Condition in text data type.

The IE 33 comprises at least one rule that is associated at least one attribute, at least one condition, and at least one action. The IE 33 generates inferred event data 36 by applying a rule 333 of at least one rule, which is taking an action 334 of said at least one action over an attribute 331 of said at least one attribute satisfying a condition 332 of said at least one condition. This specification does not cover detailed operations of the IE 33 but employs a conventional IE as known to computer programming industry. The IE 33 and the TMS 34 interoperates with each other as a problem solving system pursuant to the Dempster-Shafer Theory (DST) of evidence for modeling with uncertainty, which combines evidence from difference sources and derives a degree of belief that is represented by a belief function. The IE 33 deduces the degree of belief in DST perspective.

In the same embodiment of the present invention, a first rule specifies that a first patient requests a first action to be taken upon occurrence of a first event, wherein the first event is that time lapsed is two (2) hours since a first caretaker registers the first patient into Unit1, wherein the first patient is diagnosed with A, takes medication X, and wherein the first action is adjusting room temperature for the first patient to seventy (70) degree Fahrenheit. The first rule is set forth by respective data values of selected attributes each record from the CDB. The first event is represented by a first event record, and the first patient is represented by the first patient record. In the first event record, respective data values of Event Identification attribute, Event Location attribute, Event Description attribute, and Nurse Identification attribute are employed. The first action is described by Room Temperature attribute of another event record. In the first patient record, Patient Identification attribute, Diagnosis attribute, and Medication attribute are employed.

In the same embodiment of the present invention, a second rule specifies that a second patient requests a second action by triggering a second event, wherein the second event is that the second patient manipulates a handheld controller, wherein the second patient is diagnosed with B, takes medication Y, and wherein the second action is adjusting bed alignment for the second patient to forty-five (45) degree angle. The second rule is set forth by respective data values of selected attributes each record from the CDB. The second event is represented by a second event record, and the second patient is represented by the second patient record. In the second event record, respective data values of Event Identification attribute, Event Description attribute, Date Of Record attribute, and Time Of Record attribute are employed. The second action is described by Event Description attribute of another event record. In the second patient record, Patient Identification attribute, Diagnosis attribute, and Medication attribute are employed.

The TMS 34 stores the inferred event data 36 generated by the IE 33 as an inferred event data node 342 coupled to a dependency network 341 within the TMS 342. The TMS 34 further comprises a control data node 343 coupled to the dependency network 341, wherein the control data node 343 stores control data generated by a non-monotonic logic (NML) 351 of the SHCS module 35 by use of content of the inferred event data node 342 of the TMS 34. The TMS 34 is a knowledge representation method for representing both beliefs by use of data nodes 342, 343, and dependencies among the beliefs by use of the dependency network 341, which enables restoring consistency among all beliefs when a new belief is joined to existing beliefs of the TMS 34. The TMS 34 is configured to handle effect of retracting assumptions when the retracting assumptions are invalidated by new evidence and to keep track of multiple plausible sets of assertions which can coexist in the absence of complete knowledge.

In this specification, a conventional Assumption based Truth Maintenance System (ATMS) is used for the TMS 34, with data nodes within a dependency network, such that the TMS 34 can provide justifications for content of data nodes, recognize inconsistencies among truth of data nodes, support default reasoning to compensate a lack of knowledge in generating a new data node, remember previously computed derivations/inferences to effectively generate the new data node, and backtrack the content of data nodes based on dependency in support of non-monotonic reasoning wherein a knowledge base does not monotonically increase. This specification does not cover detailed operation of the TMS 34 as a conventional TMS is known to computer programming industry.

The SHCS module 35 generates the control data based on the inferred event data by use of the CDB 32, the IE 33, and the TMS 34, and controls operations of the hospital equipments 41 of FIG. 1 supra with the generated control data.

The NML 351 of the SHCS module 35 generates the control data by non-monotonic reasoning that extends axioms and/or rules of inference to generate the control data even when information of the inferred event data is incomplete. The NML 351 enables the TMS 34 to keep the beliefs consistent with incomplete and changing information by use of backtracking from a first conclusion and generating an alternative conclusion, and retracting a set of assertions and assumptions from which the first conclusion is derived, etc.

In the same embodiment of the present invention, the first rule of the IE 33 used in generating a first inferred event data is reverse-traced based on a new event by the NML 351, wherein the new event describes that a third patient requests a third action to be taken upon occurrence of a third event, wherein the third event is that time lapsed is two (2) hours since a third caretaker registers the third patient into Unit1, wherein the third patient is diagnosed with A, takes medication Z, and wherein the third action is adjusting room temperature for the third patient to eighty (80) degree Fahrenheit.

In the same embodiment of the present invention, the second rule of the IE 33 used in generating a second inferred event data is reverse-traced based on another new event by the NML 351, wherein the another new event describes that a fourth patient requests a fourth action by triggering a fourth event, wherein the fourth event is that the fourth patient manipulates a handheld controller, wherein the fourth patient is diagnosed with B, takes medication Y, and wherein the fourth action is adjusting bed alignment for the fourth patient to one hundred and eighty (180) degree angle.

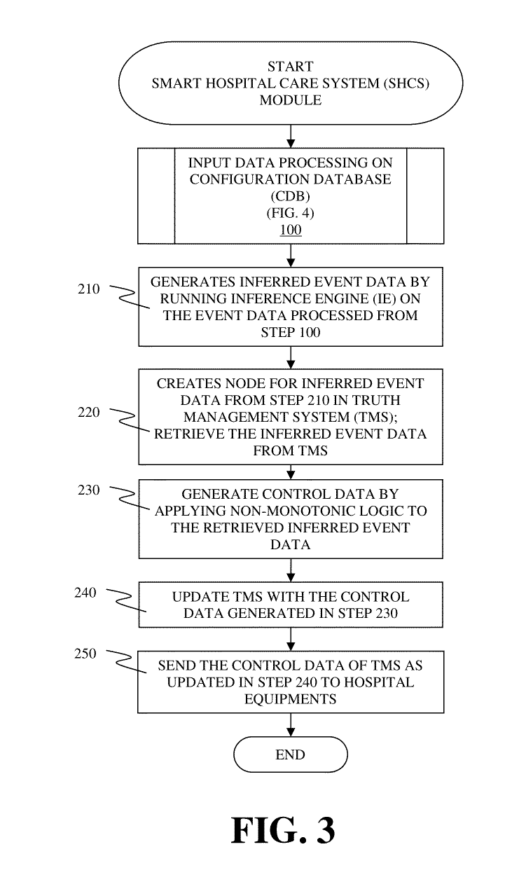

FIG. 3 is a flowchart depicting a method for automatically controlling hospital room environment as performed by the SHCS module 35 of FIG. 1 supra, in accordance with the embodiments of the present invention.

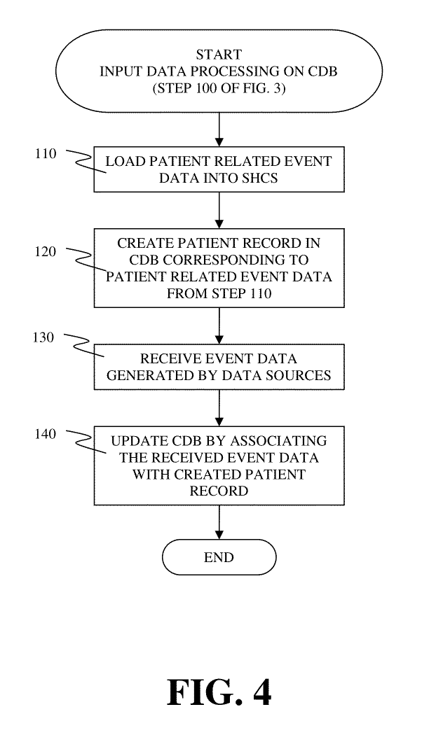

In step 100, the SHCS module processes input data from the data sources and stores resulting event data in the CDB for use in steps 210 through 250 infra. See description of FIG. 4 infra for details of input data processing in step 100. Then the SHCH module proceeds with step 200.

In step 210, the SHCS module generates inferred event data by running the inference engine (IE) with at least one inference rule on the event data processed from step 100 supra. As noted, the IE is a computer program that derives answers based on available knowledge base. The IE examines the event data and generates the inferred event data by deriving an assumption associated with a probability. In one embodiment, wherein six (6) events in the CDB support a first assumption that a patient requires 80 degrees room temperature, turn on lights at 2 a.m. with plausibility of 30% and wherein three (3) events in the CDB support a second assumption that the patient requires 70 degrees room temperature, keep the lights turned on all night with plausibility of 80%, the inferred event data may be two distinctive sets of beliefs. Then the SHCS module proceeds with step 220.

In step 220, the SHCS module stores the inferred event data generated from step 210 supra in truth management system (TMS) by creating an inferred event data node corresponding to the inferred event data node. Also the SHCS module updates respective plausibility of sets of beliefs stored in the TMS pursuant to the inferred event data. The SHCS module subsequently retrieves the inferred event data from the TMS for control data generation. Then the SHCS module proceeds with step 230.

In step 230, the SHCS module generates control data for one or more hospital equipments controlled by the SHCS by applying non-monotonic logic of the SHCS module to the inferred event data retrieved in step 220 supra. The control data is generated based on a set associated with higher plausibility value. In the same embodiment as in step 210 supra, the second assumption is selected over the first assumption because the plausibility associated with the second assumption (80%) is higher than the plausibility associated with the first assumption (30%). Then the SHCS module proceeds with step 240.

In step 240, the SHCS module updates the TMS with the control data generated in step 230 supra by storing the generated control data in the TMS as a new control data node. Also the SHCS module updates respective plausibility of sets of beliefs stored in the TMS pursuant to the control data. In the same embodiment as in steps 210 and 230 supra, wherein new event data is input from a data source, respective plausibility of the first assertion and the second assertion is updated to 60%, and 40%, respectively, within the TMS, and the first assumption is selected over the second assumption because the plausibility associated with the first assumption (60%) is higher than the plausibility associated with the second assumption (40%). Then the SHCS module proceeds with step 250.

In step 250, the SHCS module sends the control data maintained in the TMS as updated in step 240 supra to said one or more hospital equipments controlled by the SHCS. The control data may be overridden by human user interaction for safety precaution. Then the SHCS module terminates processing current instance of input data and loops back to process next instance of input data.

FIG. 4 is a flowchart depicting input data processing on the CDB in step 100 of FIG. 3 supra, as performed by the SHCS module 35 of FIG. 1 supra, in accordance with the embodiments of the present invention.

In step 110, the SHCS module loads event data of patient registration data and caretaker recordation into the SHCS. In one embodiment of the disclosure, the SHCS module collects the event data comprising patient body temperature, blood pressure, diagnosis, symptoms, medication, recommendation for equipment setting, etc., as a caretaker record each event data during admission procedure for a specific patient to a hospital. Then the SHCS module proceeds with step 120.

In step 120, the SHCS module creates a patient record and at least one event data record in the CDB corresponding to data loaded in step 110 supra. Then the SHCS module proceeds with step 130.

In step 130, the SHCS module receives additional event data generated from the data sources coupled to the SHCS. Examples of the additional event data may be, inter alia, measurement data generated by sensor devices of hospital equipments. Then the SHCS module proceeds with step 140.

In step 140, the SHCS module updates the CDB by associating the event data received from step 130 supra with patient record created in step 120 supra. Then the SHCS module proceeds with step 210 of FIG. 3 supra.

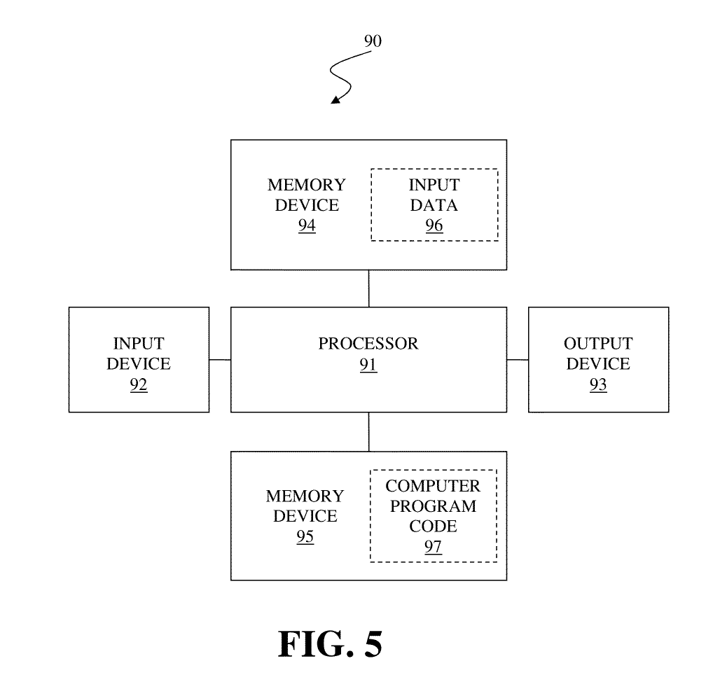

FIG. 5 illustrates a computer system 90 used for automatically controlling in-patient care environment, in accordance with the embodiments of the present invention.

The computer system 90 comprises a processor 91, an input device 92 coupled to the processor 91, an output device 93 coupled to the processor 91, and memory devices 94 and 95 each coupled to the processor 91. In this specification, the computer system 90 represents any type of programmable data processing apparatus.

The input device 92 is utilized to receive input data 96 into the computer system 90. The input device 92 may be, inter alia, a keyboard, a mouse, a keypad, a touch screen, a scanner, a voice recognition device, a sensor, a network interface card (NIC), a Voice/video over Internet Protocol (VoIP) adapter, a wireless adapter, a telephone adapter, a dedicated circuit adapter, etc. The output device 93 is utilized to communicate results generated by the computer program code 97 to a user of the computer system 90. The output device 93 may be, inter alia, a printer, a plotter, a computer screen, a magnetic tape, a removable hard disk, a floppy disk, a NIC, a VoIP adapter, a wireless adapter, a telephone adapter, a dedicated circuit adapter, an audio and/or visual signal generator, a light emitting diode (LED), etc.

Any of the components of the present invention can be deployed, managed, serviced, etc. by a service provider that offers to deploy or integrate computing infrastructure with respect to a process for automatically controlling in-patient care environment of the present invention. Thus, the present invention discloses a process for supporting computer infrastructure, comprising integrating, hosting, maintaining and deploying computer-readable code into a computing system (e.g., computing system 90), wherein the code in combination with the computing system is capable of performing a method for automatically controlling in-patient care environment.

In another embodiment, the invention provides a method that performs the process steps of the invention on a subscription, advertising and/or fee basis. That is, a service provider, such as a Solution Integrator, can offer to create, maintain, and support, etc., a process for automatically controlling in-patient care environment of the present invention. In this case, the service provider can create, maintain, and support, etc., a computer infrastructure that performs the process steps of the invention for one or more customers. In return, the service provider can receive payment from the customer(s) under a subscription and/or fee agreement, and/or the service provider can receive payment from the sale of advertising content to one or more third parties.

While FIG. 5 shows the computer system 90 as a particular configuration of hardware and software, any configuration of hardware and software, as would be known to a person of ordinary skill in the art, may be utilized for the purposes stated supra in conjunction with the particular computer system 90 of FIG. 5. For example, the memory devices 94 and 95 may be portions of a single memory device rather than separate memory devices.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. In this specification, the term “memory device” 94, 95 represent a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency (RF), etc., or any suitable combination of the foregoing.

Computer program code 97 for carrying out operations for aspects of the present invention may be written in any combination of one or more programming languages, including an object oriented programming language such as Java, Smalltalk, C++ or the like and conventional procedural programming languages, such as the “C” programming language or similar programming languages. The computer program code 97 may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. The term “computer program instructions” is interchangeable with the term “computer program code” 97 in this specification. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for automatically controlling a hospital equipment of in-patient care environment, said method comprising:
configuring, by a processor of a computer system running a module for the in-patient care environment, wherein the in-patient care environment comprises the hospital equipment, the module, a classification database (CDB), an Inference Engine (IE) and a Truth Maintenance System (TMS), event data from data sources for the module, wherein the data sources comprises patient registration, caretaker recordation, and sensor measurement, wherein the hospital equipment performs the sensor measurement;
generating at least one inferred event data by running the IE over the configured event data pursuant to predefined inference rules of the IE;
storing said at least one inferred event data from said generating as a respective inference data node of the TMS such that a respective belief associated with said at least one inferred event data varies logically dependent to other data nodes within the TMS;
producing control data by applying a respective non-monotonic logic (NML) to content of the respective inference data node of the TMS from said storing;
updating the TMS by adding a control data node corresponding to the control data from said producing; and
sending content of the control data node of the TMS from said updating to the hospital equipment such that the hospital equipment operates pursuant to the content of the control data node.

2. The method of claim 1, said configuring comprising:
loading event data related to a first patient into the module;
creating a patient record within the CDB by use of the loaded event data;
receiving new event data as generated by the data sources; and
updating the CDB by associating the received new event data to the created patient record.

3. The method of claim 1, said generating comprising:
creating a first inferred event data of said at least one inferred event data pursuant to a first inference rule selected from the predefined inference rules of the IE; and
associating a first plausibility to the created first inferred event data.

4. The method of claim 1, said producing comprising:
determining that a new event data that is inconsistent with the respective inference data node of the TMS has entered the TMS by the module;
backtracking the respective inference data node of the TMS to the event data from said configuring such that the IE generates a new inference data that is consistent with the new event data from said determining;
creating the control data based on the new event data and the new inference data.

5. The method of claim 1, said producing comprising:
determining that a first plausibility associated with a first inferred event data is greater than a second plausibility associated with a second inferred event data, wherein said at least one inferred event data comprises the first inferred event data and the second inferred event data;
selecting the second inferred event data from the TMS; and
creating the control data based on the second inferred event data from said selecting.

6. A computer program product comprising:
a computer readable storage medium having a computer readable program code embodied therein, said computer readable program code containing instructions that perform a method for verifying a signature of a signed message, said method comprising:
configuring, by a processor of a computer system running a module for the in-patient care environment, wherein the in-patient care environment comprises the hospital equipment, the module, a classification database (CDB), an Inference Engine (IE) and a Truth Maintenance System (TMS), event data from data sources for the module, wherein the data sources comprises patient registration, caretaker recordation, and sensor measurement, wherein the hospital equipment performs the sensor measurement;
generating at least one inferred event data by running the IE over the configured event data pursuant to predefined inference rules of the IE;
storing said at least one inferred event data from said generating as a respective inference data node of the TMS such that a respective belief associated with said at least one inferred event data varies logically dependent to other data nodes within the TMS;
producing control data by applying a respective non-monotonic logic (NML) to content of the respective inference data node of the TMS from said storing;
updating the TMS by adding a control data node corresponding to the control data from said producing; and
sending content of the control data node of the TMS from said updating to the hospital equipment such that the hospital equipment operates pursuant to the content of the control data node.

7. The computer program product of claim 6, said configuring comprising:
loading event data related to a first patient into the module;
creating a patient record within the CDB by use of the loaded event data;
receiving new event data as generated by the data sources; and
updating the CDB by associating the received new event data to the created patient record.

8. The computer program product of claim 6, said generating comprising:
creating a first inferred event data of said at least one inferred event data pursuant to a first inference rule selected from the predefined inference rules of the IE; and
associating a first plausibility to the created first inferred event data.

9. The computer program product of claim 6, said producing comprising:
determining that a new event data that is inconsistent with the respective inference data node of the TMS has entered the TMS by the module;
backtracking the respective inference data node of the TMS to the event data from said configuring such that the IE generates a new inference data that is consistent with the new event data from said determining;
creating the control data based on the new event data and the new inference data.

10. The computer program product of claim 6, said producing comprising:
determining that a first plausibility associated with a first inferred event data is greater than a second plausibility associated with a second inferred event data, wherein said at least one inferred event data comprises the first inferred event data and the second inferred event data;
selecting the second inferred event data from the TMS; and
creating the control data based on the second inferred event data from said selecting.

11. A computer system comprising a processor, a memory coupled to the processor, and a computer readable storage device coupled to the processor, said storage device containing program code configured to be executed by the processor via the memory to implement a method for automatically controlling a hospital equipment of in-patient care environment, said method comprising:
configuring, by the processor of the computer system running a module for the in-patient care environment, wherein the in-patient care environment comprises the hospital equipment, the module, a classification database (CDB), an Inference Engine (IE) and a Truth Maintenance System (TMS), event data from data sources for the module, wherein the data sources comprises patient registration, caretaker recordation, and sensor measurement, wherein the hospital equipment performs the sensor measurement;
generating at least one inferred event data by running the IE over the configured event data pursuant to predefined inference rules of the IE;
storing said at least one inferred event data from said generating as a respective inference data node of the TMS such that a respective belief associated with said at least one inferred event data varies logically dependent to other data nodes within the TMS;
producing control data by applying a respective non-monotonic logic (NML) to content of the respective inference data node of the TMS from said storing;
updating the TMS by adding a control data node corresponding to the control data from said producing; and
sending content of the control data node of the TMS from said updating to the hospital equipment such that the hospital equipment operates pursuant to the content of the control data node.

12. The computer system of claim 11, said configuring comprising:
loading event data related to a first patient into the module;
creating a patient record within the CDB by use of the loaded event data;
receiving new event data as generated by the data sources; and
updating the CDB by associating the received new event data to the created patient record.

13. The computer system of claim 11, said generating comprising:
creating a first inferred event data of said at least one inferred event data pursuant to a first inference rule selected from the predefined inference rules of the IE; and
associating a first plausibility to the created first inferred event data.

14. The computer system of claim 11, said producing comprising:
determining that a new event data that is inconsistent with the respective inference data node of the TMS has entered the TMS by the module;
backtracking the respective inference data node of the TMS to the event data from said configuring such that the IE generates a new inference data that is consistent with the new event data from said determining;
creating the control data based on the new event data and the new inference data.

15. The computer system of claim 11, said producing comprising:
determining that a first plausibility associated with a first inferred event data is greater than a second plausibility associated with a second inferred event data, wherein said at least one inferred event data comprises the first inferred event data and the second inferred event data;
selecting the second inferred event data from the TMS; and
creating the control data based on the second inferred event data from said selecting.

16. A process for supporting computer infrastructure, said process comprising providing at least one support service for at least one of creating, integrating, hosting, maintaining, and deploying computer-readable code in a computing system, wherein the code in combination with the computing system is capable of performing a method for automatically controlling a hospital equipment of in-patient care environment, said method comprising:
configuring, by a processor of a computer system running a module for the in-patient care environment, wherein the in-patient care environment comprises the hospital equipment, the module, a classification database (CDB), an Inference Engine (IE) and a Truth Maintenance System (TMS), event data from data sources for the module, wherein the data sources comprises patient registration, caretaker recordation, and sensor measurement, wherein the hospital equipment performs the sensor measurement;
generating at least one inferred event data by running the IE over the configured event data pursuant to predefined inference rules of the IE;
storing said at least one inferred event data from said generating as a respective inference data node of the TMS such that a respective belief associated with said at least one inferred event data varies logically dependent to other data nodes within the TMS;
producing control data by applying a respective non-monotonic logic (NML) to content of the respective inference data node of the TMS from said storing;
updating the TMS by adding a control data node corresponding to the control data from said producing; and
sending content of the control data node of the TMS from said updating to the hospital equipment such that the hospital equipment operates pursuant to the content of the control data node.

17. The process of claim 16, said configuring comprising:
loading event data related to a first patient into the module;
creating a patient record within the CDB by use of the loaded event data;
receiving new event data as generated by the data sources; and
updating the CDB by associating the received new event data to the created patient record.

18. The process of claim 16, said generating comprising:
creating a first inferred event data of said at least one inferred event data pursuant to a first inference rule selected from the predefined inference rules of the IE; and
associating a first plausibility to the created first inferred event data.

19. The process of claim 16, said producing comprising:
determining that a new event data that is inconsistent with the respective inference data node of the TMS has entered the TMS by the module;
backtracking the respective inference data node of the TMS to the event data from said configuring such that the IE generates a new inference data that is consistent with the new event data from said determining;
creating the control data based on the new event data and the new inference data.

20. The process of claim 16, said producing comprising:
determining that a first plausibility associated with a first inferred event data is greater than a second plausibility associated with a second inferred event data, wherein said at least one inferred event data comprises the first inferred event data and the second inferred event data;
selecting the second inferred event data from the TMS; and
creating the control data based on the second inferred event data from said selecting.
